(19) United States
(12) Patent Application Publication
(10) Pub. No.: US 2006/0266940 A1
(43) Pub. Date: Nov. 30, 2006

(54) System and method for studying power of laser beam

(75) Inventor: Sang Yeal Park, Suwon-Si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/371,096

(22) Filed: Mar. 9, 2006

(30) Foreign Application Priority Data
May 26, 2005 (KR) 2005-44364

(51) Int. Cl. G01D 18/00

(52) U.S. Cl. 250/252.1

(57) ABSTRACT

A laser beam power studying system and method. A laser beam is emitted and a power of the laser beam at a position to be incident on a recording medium is measured. A part of the laser beam is converted to a photovoltage signal corresponding to an amount of the laser beam and amplified with reference to a reference voltage signal to provide an output voltage signal. A difference between the output voltage signal and the reference voltage signal is obtained at a plurality of different laser beam power levels, to derive a difference to laser beam power correlation.

### CROSS-REFERENCE TO RELATED APPLICATIONS

This application claims the benefit of Korean Patent Application No. 2005-44364, filed on May 26, 2005 in the Korean Intellectual Property Office, the disclosure of which is incorporated herein by reference.

### BACKGROUND OF THE INVENTION

1. Field of the Invention

Aspects of the present invention relate to a system for and a method of studying power of a laser beam, and more particularly, to a laser beam power studying system and method of presetting references for control of power of a laser beam in a manufacturing process of an optical recording/reproduction apparatus.

2. Description of the Related Art

In general, an optical recording/reproduction apparatus includes a recording automatic power control (APC) circuit controlling power of a laser beam in a recording operation, and a reproduction APC circuit controlling power of a laser beam in a reproduction operation, and is adapted to maintain the power of the laser beam at a predetermined value using the recording or reproduction APC circuit when recording or reproducing data on or from an optical disc.

A conventional optical recording/reproduction apparatus is disclosed in the prior art section of Korean Patent Laid-open Publication No. 2004-2232. As disclosed in the Korean publication 2004-2232, the conventional optical recording/reproduction apparatus includes a radio frequency (RF) unit having recording and reproduction APC circuits, a read only memory (ROM) storing offset values of the recording and reproduction APC circuits, a voltage value of recording laser beam power, a voltage value of reproduction laser beam power, an output signal level of a front photo diode (FPD) corresponding to the voltage value of recording laser beam power, a microcomputer setting offsets of the recording and reproduction APC circuits, a voltage of recording laser beam power and a voltage of reproduction laser beam power on the basis of the values stored in the ROM, respectively, when the optical recording/reproduction apparatus is powered on, and an optical pickup adjusting the voltage of the recording or reproduction laser beam power in response to an output signal from the front photodiode in a recording or reproduction mode. With this configuration, the conventional optical recording/reproduction apparatus is adapted to properly control the laser beam power in the reproduction or recording mode.

In particular, the conventional optical recording/reproduction apparatus utilizes the output signal level of the front photo diode corresponding to the voltage value of the recording laser beam power stored in the ROM as a reference for the control of the recording laser beam power. Although not disclosed in detail in the Korean publication 2004-2232, the output signal level of the front photo diode corresponding to the voltage value of the recording laser beam power is obtained by measuring an output signal from the front photo diode in response to varying powers of a laser beam to the optical disc when the reference for the control of the recording laser beam power is set.

Where the output signal level of the front photo diode corresponding to the voltage value of the recording laser beam power is used as the reference for the control of the recording laser beam power, the output signal level of the front photo diode measured without external disturbances such as temperature changes or noise in a measurement site can serve as an accurate reference. However, the output signal level of the front photo diode measured under the influence of the external disturbances may be not an accurate reference.

That is, the output signal level of the front photo diode measured in the presence of the external disturbances can assume different values due to the influence of the external disturbances, and thus the output signal level so measured cannot serve as an accurate reference. If the recording laser beam power of the laser beam is adjusted on the basis of the output signal level of the front photo diode measured in the presence of the external disturbances, the recording laser beam power can be inappropriately adjusted. This problem also occurs when a reference for control of the reproduction laser beam power is set.

### SUMMARY OF THE INVENTION

An aspect of the invention is to provide a laser beam power studying system and a method of setting references for control of laser beam power which are not affected by various external disturbances.

In accordance with an aspect of the invention, there is provided a laser beam power studying method including: emitting a laser beam and measuring laser beam power of the laser beam; receiving a part of the laser beam and converting the received laser beam part into a photovoltage signal corresponding to an amount of the received laser beam part; amplifying the photovoltage signal with reference to a reference voltage signal to provide an output voltage signal; calculating a difference between the output voltage signal and the reference voltage signal; and repeating a cycle of operations including the emitting, the receiving, the amplifying and the calculating, to derive a difference-to-laser beam power correlation.

The laser beam power of the laser beam may be regularly increased or regularly decreased while the cycle of operations is repeated.

The difference-to-laser beam power correlation may be represented by a difference-to-laser beam power graph or an approximate expression of the graph.

The reference voltage signal may be measured each time the cycle of operations is repeated.

The difference-to-laser beam power correlation may be used for control of the laser beam power in a recording or reproduction mode of an optical recording/reproducing apparatus.

The received part of the laser beam part may be converted into a photocurrent signal corresponding to the received laser beam part, and the photocurrent signal may in turn be converted into the photovoltage signal corresponding to the photocurrent signal.

In accordance with another aspect of the invention, there is provided a laser beam power studying system including: a laser diode emitting a laser beam; a laser beam power meter measuring laser beam power of the laser beam; a front photo diode receiving a part of the laser beam and converting the received laser beam part into a photocurrent signal; an analog signal processor amplifying an photovoltage signal obtained by performing a current/voltage conversion operation on the photocurrent signal, with reference to a reference voltage signal, to provide an output voltage signal; and a microcomputer calculating a difference between the output voltage signal and the reference voltage signal in a laser beam power studying operation by repeatedly varying the laser beam power, to derive a difference-to-laser beam power correlation.

The microcomputer may be adapted to control the laser beam power of the laser beam such that it is regularly increased or regularly decreased in the laser beam power studying operation.

The laser diode drive voltage values of multiple levels, which are set by the microcomputer so as to enable the laser diode to emit a laser beam whose power may be regularly increased or regularly decreased in the laser beam power studying operation, are stored in a laser diode driver driving the laser diode.

The difference-to-laser beam power correlation may be derived using a laser diode drive voltage-laser beam power relation and a laser diode drive voltage-difference relation.

The difference-to-laser beam power correlation may be represented by a difference-to-laser beam power graph or an approximate expression of the graph.

The analog signal processor may include an amplifier amplifying the photovoltage signal, and a multiplexer selectively outputting the output voltage signal and the reference voltage signal to the microcomputer. The output voltage signal and the reference voltage signal may be outputted to the microcomputer each time the laser beam power is varied in the laser beam power studying operation.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a configuration of a laser beam power studying system according to an embodiment of the present invention;

FIG. 2 is a block diagram showing a configuration of an analog signal processor of FIG. 1;

FIG. 3 is a flow chart illustrating a method of studying laser beam power according to an embodiment of the present invention;

FIGS. 4A, 4B, 4C and 4D are various graphs derived using the laser beam power studying method described with reference to FIG. 3;

FIGS. 5A-5D are waveforms illustrating a relationship between a reference voltage signal and an output voltage signal without influence of external disturbances; and

FIGS. 6A-6D are waveforms illustrating a relationship between the reference voltage signal and the output voltage signal under an influence of external disturbances.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

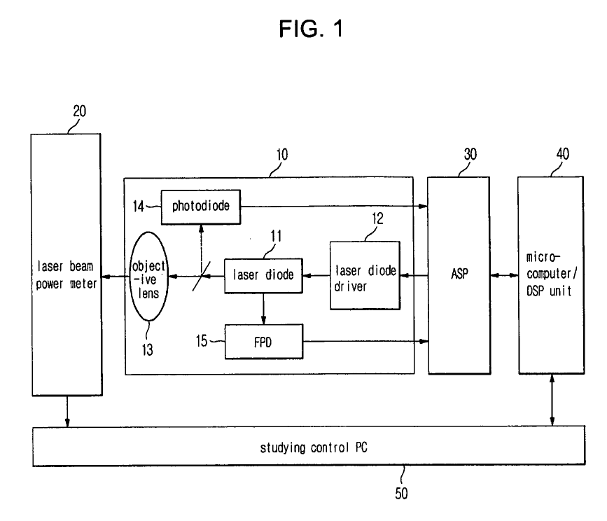

FIG. 1 shows the configuration of a laser beam power studying system according to an embodiment of the present invention. As shown in FIG. 1, the laser beam power studying system comprises a pickup 10, a laser beam power meter 20, an analog signal processor (ASP) 30, a microcomputer/digital signal processor (DSP) unit 40, and a studying control personal computer (PC) 50.

The pickup 10 includes a laser diode 11 emitting a laser beam, a laser diode driver 12 driving the laser diode 11, an objective lens 13 focusing the laser beam from the laser diode 11 on an optical disc to form a spot thereon, a photodiode 14 receiving a laser beam reflected from the optical disc and converting the received laser beam into a current signal, and a front photodiode (FPD) 15 receiving a part of the laser beam from the laser diode 11 and converting the received laser beam part into a photocurrent signal corresponding to an amount of the received part of the laser beam. The laser beam emitted from the laser diode 11 is fed mostly to the objective lens 13, and partially to the FPD 15.

The laser diode driver 12 includes a register (not shown) storing laser diode drive voltage values of multiple levels to enable the laser diode 11 to emit laser beams with multiple power levels in a laser beam power studying operation. The stored drive voltage values are set by the microcomputer/DSP unit 40. In the laser beam power studying operation, the laser diode driver 12 sequentially supplies the laser diode drive voltage values stored in the register to the laser diode 11 to vary the power of a laser beam to be emitted from the laser diode 11.

The photocurrent signal from the FPD 15 is converted into a photovoltage signal Vfpdo by a current to voltage (I/V) converter (not shown) and the photovoltage signal Vfpdo is then input to the ASP 30. A reference voltage signal Vref is also applied to the ASP 30. The FPD 15 has a characteristic of outputting a photocurrent signal of a lower level when receiving a laser beam with larger power. In addition, the level of the photocurrent signal varies corresponding to changes in the level of the reference voltage signal under the influence of external disturbances. For example, where the power of a laser beam is 0 mw, 1 mw and 2 mw, the level of a photovoltage signal Vfpdo from the pickup 10 is 2.5V, 2.0V and 1.5V, respectively. Where the reference voltage signal Vref is 2.4V because of and the power of the laser beam is 1 mw and 2 mw, the level of the photovoltage signal Vfpdo from the pickup 10 is 1.9V and 1.4V, respectively.

The laser beam power meter 20 acts to measure power of a laser beam passed through the objective lens 13.

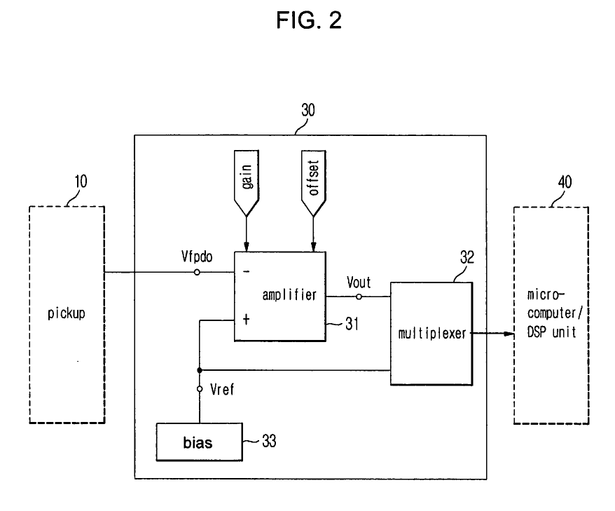

The ASP 30 includes, as shown in FIG. 2, an amplifier 31, and a multiplexer 32. The amplifier 31 has a plus terminal receiving the reference voltage signal Vref, a minus terminal receiving the photovoltage signal Vfpdo from the pickup 10, and an output terminal outputting an output voltage signal Vout, which is the photovoltage signal Vfpdo that is amplified by a gain of the amplifier 31 on relative to the voltage signal Vref. At this time, the gain of the amplifier 31 and an offset thereof are set by the microcomputer/DSP unit 40, and the reference voltage signal Vref is set to a preset value.

The multiplexer 32 is connected with the output terminal and a bias terminal 33, and is adapted to switch an output thereof between the output voltage signal Vout and the reference voltage signal Vref. The microcomputer/DSP unit 40 functions to store the reference voltage signal Vref and output voltage signal Vout from the ASP 30, and to calculate a difference between the stored reference voltage signal Vref and the stored output voltage signal Vout to derive a correlation between the calculated difference and the corresponding laser beam power. The microcomputer/DSP unit 40 also receives analog signals other than the reference voltage signal Vref and output voltage signal Vout from the ASP 30, converts the received analog signals into digital signals, processes the converted digital signals, and controls the pickup 10 and ASP 30 according to the processed signals. The studying control PC 50 acts to control the overall operation of the laser beam power studying system. Although the microcomputer/DSP unit 40 has been disclosed in the present embodiment to be a single block, the microcomputer and the DSP may be implemented as separate blocks.

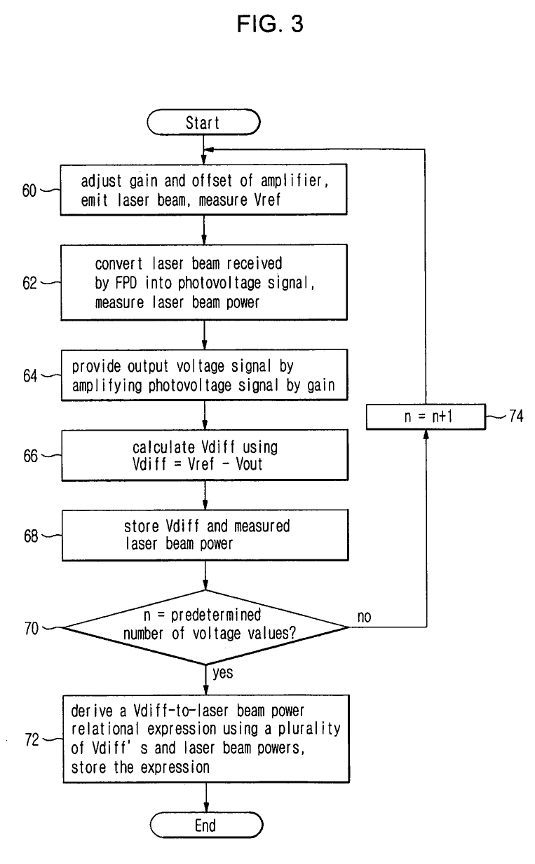

Referring now to FIGS. 3-6, a laser beam power studying method according to an embodiment of the present invention will be described. Notably, it is difficult to actually measure and control power of a laser beam passed through the objective lens 13 of the pickup 10 in a recording or reproduction mode of an optical recording/reproduction apparatus. For this reason, references for control of power of a laser beam through the recording or reproduction laser beam power studying operation may be preset in a manufacturing process of the optical recording/reproduction apparatus and the laser beam power in the recording or reproduction mode may be controlled based on the preset references.

For a laser beam power studying operation, first, the microcomputer/DSP unit 40 sets a desired gain and offset of the amplifier 31. Then, the microcomputer/DSP unit 40 applies a first one of n (where n is a natural number≧2) laser diode drive voltage values stored in the register of the laser diode driver 12 to the laser diode 11 such that the laser diode 11 emits a laser beam of power corresponding to the first laser diode drive voltage value. The multiplexer 32 is adapted to output a reference voltage signal Vref to the microcomputer/DSP unit 40 in operation 60.

The laser beam emitted from the laser diode 11 is passed through the objective lens 13 and the power thereof is then measured by the laser beam power meter 20. The FPD 15 receives a part of the laser beam from the laser diode 11 and converts it into a photocurrent signal, which is in turn converted into a photovoltage signal Vfpdo, and then the photovoltage signal Vfpdo is inputted to the minus terminal of the amplifier 31 in operation 62. The amplifier 31 amplifies the photovoltage signal Vfpdo inputted thereto by the gain of the amplifier 31 on the basis of the reference voltage signal Vref and outputs the amplified photovoltage signal Vfpdo as an output voltage signal Vout. The output voltage signal Vout is inputted to the microcomputer/DSP unit 40 through a switching operation of the multiplexer 32 in operation 64.

The microcomputer/DSP unit 40 calculates a difference Vdiff between the reference voltage signal Vref and the output voltage signal Vout, stores the calculated difference Vdiff in operation 66, and also stores the laser beam power measured by the laser beam power meter 20 in operation 68. Thereafter, the microcomputer/DSP unit 40 determines whether operations 60-68 have been repeated a predetermined number of times in operation 70. Upon determining that the above process has not been repeated the predetermined number of times, the microcomputer/DSP unit 40 repeats the process by branching back to operation S60 in operation 74. However, if the above process is determined to have been repeated the predetermined number of times, the microcomputer/DSP unit 40 obtains a difference-to-laser beam power relational expression on the basis of a plurality of stored differences Vdiff and a plurality of stored laser beam powers, and stores the obtained relational expression in operation 72. Note that the laser diode drive voltage values stored in the register of the laser diode driver 12 are sequentially applied to the laser diode 11 so that a laser beam with different power can be emitted from the laser diode 11 each time the above process is repeated.

With the calculated difference Vdiff between the reference voltage signal Vref and the output voltage signal Vout, the difference-to-laser beam power relational expression can be obtained by deriving a difference-to-laser beam power correlation through direct utilization of the stored differences Vdiff and stored laser beam powers. The relational expression can also be obtained by deriving a laser diode drive voltage-to-laser beam power correlation or a difference-to-laser diode drive voltage correlation.

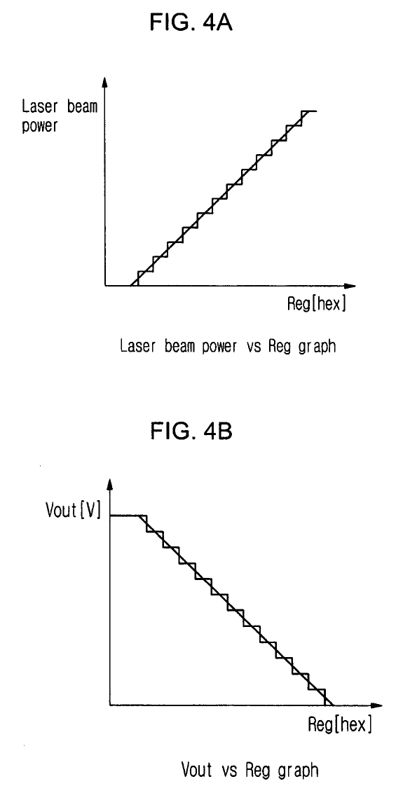

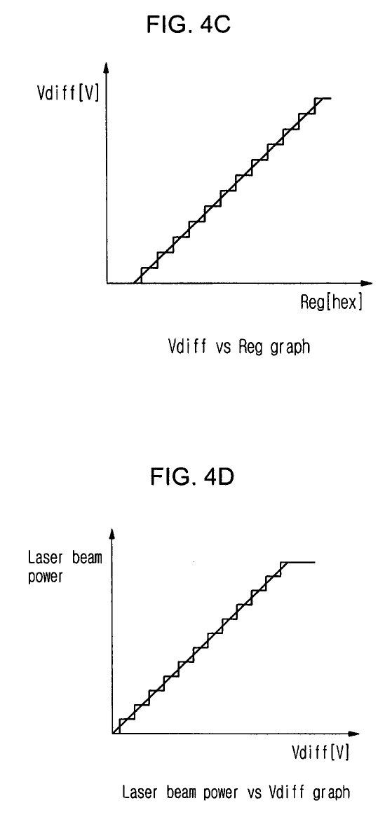

FIGS. 4A, 4B, 4C and 4D are graphs illustrating a difference-to-laser beam power correlation to be stored in the microcomputer/DSP unit 40. In the graph of FIG. 4A, the x-axis denotes laser diode drive voltage values stored in the register Reg of the laser diode driver 12, and the y-axis denotes corresponding laser beam powers at the respective laser diode drive voltage values. It can be understood from this graph that the power of a laser beam from the laser diode 11 increases with increasing laser diode drive voltage.

In the graph of FIG. 4B, the x-axis denotes the laser diode drive voltage values stored in the register Reg of the laser diode driver 12, and the y-axis denotes an output voltage signal Vout. It can be understood from this graph that the output voltage signal Vout decreases with increasing laser diode drive voltage. This is because a photovoltage signal Vfpdo to the amplifier 31 decreases with increasing laser beam power.

In the graph of FIG. 4C, the x-axis denotes the laser diode drive voltage values stored in the register Reg of the laser diode driver 12, and the y-axis denotes a difference Vdiff between a reference voltage signal Vref and the output voltage signal Vout. It can be understood from this graph that the difference Vdiff between the reference voltage signal Vref and the output voltage signal Vout increases with increasing laser diode drive voltage. This result can be easily confirmed if values of the graph in FIG. 4B are subtracted from the reference voltage signal Vref, respectively.

In the graph of FIG. 4D, the x-axis denotes the difference Vdiff between the reference voltage signal Vref and the output voltage signal Vout, and the y-axis denotes the laser beam power. It can be understood from this graph that the laser beam power increases with increasing difference Vdiff between the reference voltage signal Vref and the output voltage signal Vout. The microcomputer/DSP unit 40 derives a first-order approximate expression for this graph by obtaining the slope and y-intercept of the approximate expression, and stores the slope and y-intercept, which become references for control of laser beam power in the optical recording/reproducing apparatus.

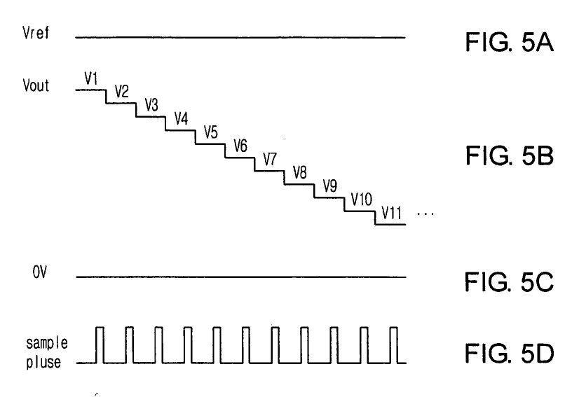

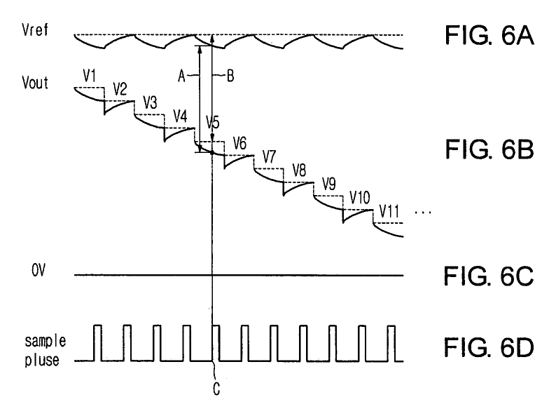

FIGS. 5A, 5B, 5C and-5D are waveforms illustrating several cases of the reference voltage signal Vref and the output voltage signal Vout obtained through the laser beam power studying operation without influence of external disturbances. FIGS. 6A, 6B, 6C and 6D are waveforms illustrating the reference voltage signal Vref and the output voltage signal Vout obtained through the laser beam power studying operation under the influence of external disturbances. Pulse waves shown in FIG. 5D and FIG. 6D denote sampling pulses.

As shown in FIGS. 5A-5D, if there is no influence of the external disturbances, the reference voltage signal Vref maintains a fixed value, and the output voltage signal Vout regularly decreases with increasing power of a laser beam. Hence, without the influence of the external disturbances, there is no significant problem even if the laser beam power is adjusted using the relationship between the output voltage signal Vout and the laser beam power.

However, as shown in FIG. 6B, references which are set under the influence of the external disturbances using the conventional laser beam power studying method can be inadequate for control of the laser beam power. Namely, under the influence of the external disturbances, as shown in FIG. 6A, the reference voltage signal Vref can assume different levels each time it is measured. Because of the external disturbances, different from the cases shown in FIGS. 5A-5D, the output voltage signal Vout does not regularly decrease, but changes irregularly. Consequently, there are various problems if the laser beam power is adjusted using the relationship between the laser beam power and the output voltage signal Vout of FIG. 6B.

For this reason, the difference between the reference voltage signal Vref and the output voltage signal Vout is used. If the reference voltage signal Vref and the output voltage signal Vout are sampled at a point C as shown in FIGS. 6A-6D, the difference between Vref and Vout is a value A. The value A is the same as a value B, which is the difference between the reference voltage signal Vref and the output voltage signal Vout in the case where there is no influence of the external disturbances. The difference between the reference voltage signal Vref and the output voltage signal Vout under the influence of the external disturbances is the same as that without the influence of the external disturbances. The values of Vout without external disturbances are shown as dashed lines in FIG. 6B. The present invention utilizes a difference-to-laser beam power relational expression or a graph depicting this relational expression, and thus can set highly reliable references for the control of the laser beam power.

In summary, aspects of the present invention provide a laser beam power studying system and method wherein a difference between a reference voltage signal and an output voltage signal is calculated to derive a correlation between the difference and laser beam power, and the derived correlation is used to control the laser beam power, thereby preventing inadequate control of the laser beam power caused by setting inaccurate references due to ambient temperature changes or noise in a laser beam power studying operation.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A laser beam power studying method comprising:
performing a sequence of operations comprising:
emitting a laser beam and measuring a power of the laser beam,
converting a part of the laser beam into a photovoltage signal, amplifying the photovoltage signal with reference to a reference voltage signal to provide an output voltage signal, and
calculating a difference between the output voltage signal and the reference voltage signal; and
repeating the sequence of operations while varying the laser beam power, to derive a correlation between the measured power of the laser beam and the calculated difference.

2. The laser beam power studying method as set forth in claim 1, wherein the power of the laser beam is regularly increased or regularly decreased to vary the laser beam power

3. The laser beam power studying method as set forth in claim 2, wherein the correlation is represented by a graph or an approximate expression of the graph.

4. The laser beam power studying method as set forth in claim 1, wherein the reference voltage signal is measured each time the sequence of operations is repeated.

5. The laser beam power studying method as set forth in claim 1, wherein the correlation is used to control the laser beam power in a recording or reproduction mode of an optical recording/reproducing apparatus.

6. The laser beam power studying method as set forth in claim 1, wherein the converting of the part of the laser beam into a photovoltage signal comprises:
receiving a photocurrent signal corresponding to the received laser beam part, and
converting the photocurrent signal into the photovoltage signal.

7. A laser beam power studying system comprising:
a laser diode emitting a laser beam;
a laser beam power meter measuring a power of the laser beam;
a front photo diode receiving a part of the laser beam and converting the received laser beam part into a photocurrent signal;
an analog signal processor amplifying a photovoltage signal obtained by performing a current/voltage conversion operation on the photocurrent signal, with reference to a reference voltage signal, to provide an output voltage signal; and
a microcomputer calculating a difference between the output voltage signal and the reference voltage signal and deriving a correlation between the calculated difference and the measured power of the laser beam by repeatedly varying the laser beam power and the calculating of the difference between the output voltage signal and the reference voltage signal.

8. The laser beam power studying system as set forth in claim 7, wherein:
the microcomputer controls the emitted laser beam power to regularly increase or regularly decrease the laser beam power.

9. The laser beam power studying system as set forth in claim 8, wherein:
a plurality of laser diode drive voltage values, which enable the laser diode to emit the laser beam having the increased or decreased power levels, are stored in a laser diode driver driving the laser diode.

10. The laser beam power studying system as set forth in claim 9, wherein:
the correlation is derived using a laser diode drive voltage-laser beam power relation and a laser diode drive voltage-difference relation.

11. The laser beam power studying system as set forth in claim 7, wherein:
the correlation is represented by a graph or an approximate expression of the graph.

12. The laser beam power studying system as set forth in claim 7, wherein:
the analog signal processor comprises:
an amplifier amplifying the photovoltage signal, and
a multiplexer selectively outputting the output voltage signal and the reference voltage signal to the microcomputer, the output voltage signal and the reference voltage signal being outputted to the microcomputer each time the laser beam power is varied.

13. A method of setting a power level of a laser beam at a recording medium in an optical recording/reproducing apparatus, the method comprising:
measuring a power level of the laser beam at a first position corresponding to the recording medium at a plurality of different power levels;
measuring a power level of the laser beam at a second position for each different power level measured at the first position and generating a respective first voltage signal corresponding to the power level at the second position;
amplifying a difference between each first voltage signal and a respective reference signal to generate a plurality of respective second voltage signals;
calculating a difference value between each generated second voltage signal and the corresponding reference signal to generate a plurality of calculated difference values; and
storing the plurality of calculated difference values in correspondence with the power levels measured at the first position.

14. The method of claim 13, further comprising:
generating a first order equation based on the plurality of calculated difference values; and
generating a laser power level based on the first order equation during recording/reproduction to/from the recording medium.

15. The method of claim 13, further comprising:
generating slope and intercept values for a first order equation based on the calculated difference values;
storing the slope and intercept values;
generating the first order equation based on the stored slope and intercept values; and
generating a laser power level based on the first order equation during recording/reproduction to/from the recording medium.

16. The method of claim 14, further comprising:
smoothing data corresponding to the calculated difference values during the generating of the first order equation to compensate for disturbances occurring during the measuring of the power levels, the generation of the second voltage signals or the calculating on the difference values.

17. The method of claim 15, further comprising:
smoothing data corresponding to the calculated difference values during the generating of the slope and intercept values.

18. The method of claim 13, further comprising:
generating a first order equation based on the plurality of calculated difference values;
generating discrete laser diode drive values based on the first order equation; and
generating a laser power level based on the discrete diode drive values during recording/reproduction to/from the recording medium.

19. The method of claim 13, further comprising:
generating a first order equation based on the plurality of calculated difference values;
generating discrete laser diode drive values based on the first order equation;
storing the generated discrete laser diode drive values; and
generating a laser power level based on the stored discrete diode drive values during recording/reproduction to/from the recording medium.

20. The method of claim 13, further comprising:
smoothing data corresponding to the calculated difference values;
generating discrete laser diode drive values based on the smoothed data; and
generating a laser power level based on the discrete diode drive values during recording/reproduction to/from the recording medium.

21. The method of claim 13, further comprising:
smoothing data corresponding to the calculated difference values;
generating discrete laser diode drive values based on the smoothed data;
storing the generated discrete laser diode drive values; and
generating a laser power level based on the stored discrete diode drive values during recording/reproduction to/from the recording medium.
